(19) United States
(12) Patent Application Publication
(10) Pub. No.: US 2010/0083095 A1
(43) Pub. Date: Apr. 1, 2010

(54) Method for Extracting Data from Web Pages

(76) Inventors: Daniel N. Nikovski, Brookline, MA (US); Alan W. Esenther, Ashland, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/239,859

(22) Filed: Sep. 29, 2008

(51) Int. Cl. G06F 17/30

(52) U.S. Cl. 715/234

(57) ABSTRACT

Embodiments of the invention describe a computer-implemented method for extracting data from web pages. During a learning stage, the embodiments receive a template web page represented by a template Document Object Model (DOM) and select a record node, which is a root node of a sub-tree of the template DOM that contains data to be extracted. After that, a record node sub-tree and data field sub-paths are stored in a memory, wherein the record node is a root node of the record node sub-tree, and the data field sub-paths are relative paths of the template DOM from the record node to data field nodes. During the extraction stage, a web page represented by a DOM-tree is received and a matched sub-tree of the DOM-tree according to a structure of the record node sub-tree is identified. Next, data from the matched sub-tree according to the data field sub-paths are extracted.

### FIELD OF THE INVENTION

This invention relates generally to analyzing web pages, and more particularly to extracting data from web pages.

### BACKGROUND OF THE INVENTION

Web Pages

A web page or webpage is a resource of information that is suitable for the World Wide Web (WWW) and can be accessed using a web browser. The format of the information is usually Hypertext Mark-up Language (HTML), or Extensible Hypertext Markup Language (XHTML), and may provide navigation to other web pages via hypertext links. Web pages may be retrieved from a local computer or from a remote web server using protocols such as hypertext transfer protocol (HTTP).

Usually, the web pages are intended for human users. As a consequence, the layout of most web pages is designed for maximal user convenience, focusing on the visual representation of the web page. This is usually achieved by encoding both the content and the visual layout of a web page by means of the HTML.

It is often necessary to combine information from one or more web pages. For example, for trip scheduling using several modes of transportation (airplane, train, taxi), it may be necessary to consult a train schedule, a list of available flights, and a mapping service, together with the specific information about the origin and destination of the trip. In most cases, this information is available from different web sites of transportation providers, and it would not be a problem for the human user to retrieve and use the information to schedule a trip.

Sometimes, it is advantageous to analyze and use the content of web pages by computer programs. Although, it is easy for human users to comprehend the content of web pages encoded and rendered according to HTML, it is harder for computer programs to do so. The main reason is that the stream of HTML code for a web page can contain at least three distinct types of information: actual data that are to be communicated to users, explanatory text that labels the data, and formatting instructions, such as HTML tags.

Web Scraping

Web scraping methods extract content from a website for the purpose of transforming the content into another format suitable for use in another context. Some users who scrape websites may wish to store the information in their own databases or otherwise manipulate the information. Others may utilize data extraction techniques as a means for obtaining the most recent data possible, particularly when working with information that is subject to frequent changes. Investors analyzing stock prices, realtors researching home listings, meteorologists studying weather patterns, or insurance agents following insurance prices are some examples of users who might perform web scraping.

Web scraping software is readily available. The Perl language, and modules from the Comprehensive Perl Archive Network, contains many features suitable for screen scraping. Microsoft has built into its web services implementation the ability to create a web service which extracts data from a web page with the help of an extension to the WSDL standard and the use of regular expressions. The PHP is a general purpose scripting language. The current PHP includes a number of Extensible Markup Language (XML) and Document Object Model (DOM) additions, including functions to parse badly formed HTML documents into DOM-trees, and work on the documents as if they were well-formed in XML. Java offers support for web scraping techniques, by leveraging the W3C's XQuery specification. Python and Ruby also have libraries for web scraping.

The methods for extracting data from web pages generally fall into two main categories: supervised and unsupervised.

Supervised Methods

Supervised methods require explicit instruction on either where the data fields are in a web page, or how to extract the data fields from the source code of a web page. Some supervised methods use extraction rules that match elements in the HTML stream. Usually, writing such rules requires significant programming skill. Other supervised methods require a human user to point to the data items on a rendered web page, for example by highlighting them by means of a computer mouse, and after that the corresponding extraction rules are automatically generated.

Unsupervised Methods

Unsupervised methods require input of several instances of a web page, after which the methods can infer from the instances what part of the web page is data, and what part is formatting and labeling text. These methods usually compare multiple instances of a web page, and treat the variable part as data fields and the non-changing part as a formatting template. One shortcoming of those methods is that they require multiple example instances, for example search results obtained for different search words.

The structure of a web page can be represented by its DOM-tree. The DOM (Document Object Model) itself is an application programming interface (API) that enables access to the components of a web page from programming languages such as JavaScript and C++. The content of a web page can conceptually be represented as a tree, where the entire document is the root of the tree, and subsequent visual elements, such as text paragraphs, boldface text, tables, lists, etc., are sub-trees. For example, boldface text in a table will be represented by the following path of nodes in the DOM-tree, in descending order: a table node whose parent is the document node (root of the tree), a table row node whose parent is the table node, a table cell node whose parent is the table row node, a boldface selection node whose parent is the table cell node, and finally a text node whose parent is the boldface selection node. The path to a tree node (leaf or internal) in a DOM-tree can be represented by an XPATH expression that includes the traversal sequence in the tree that is required to reach this node from the root of the tree.

Web Page Structure

Two web pages have the same structure when they have identical DOM-trees, with the exception of the leaf nodes of the tree, which can differ. That is, if two documents contain tables that both have two rows and four columns each, but different text in the cells of the tables, they have the same structure. However, if one web page contains a table with two rows, and the other web page contains a table with three rows, the two documents have different structure.

Both supervised and unsupervised methods perform well on web pages with fixed structure, because the information to be extracted can always be found at the exact same location in the DOM-tree. However, when the structure of web pages is variable, the path to the actual data fields in the DOM-tree of the pages also varies, and specifying how to extract the necessary data is not easy.

One specific variation in the web page structure is very common and of high practical significance. This variation arises when a web page contains a variable number of data records, each of which has the same repetitive structure. For example, the output of a search engine can contain a variable number of results. Each of these results has the same structure. For example, the result of searching an on-line bookstore depends on search criteria. However, each book will be represented by a record that has the same data fields, e.g., title, author, publisher, year, and usually will be encoded in exactly the same way for every record.

Simple supervised methods relying on explicit paths to data fields would fail in this case, because the number of extraction rules that are needed depends on the number of records in the page, which is not known beforehand. Unsupervised methods might fail as well, because they can detect repetitive structure in a part of the web page that does not contain any valuable data.

To deal with web pages with repetitive structure, web content mining methods generate possible extraction rules, and present them to a user in a decreasing order of suitability, see U.S. Pat. No. 7,210,136. A disadvantage of that method is that the user must choose the correct extraction rule among many possibilities, and identifying the correct rule might be difficult.

It is desired to provide a user with a method to extract data from a variable number of data records wherein the list of data records has repetitive structure.

### SUMMARY OF THE INVENTION

The embodiments of the invention provide a method for extracting data from web pages. The web pages store data in fields. The fields form data records, which have a repetitive structure, e.g., lists or tables with variable number of items or rows.

The embodiments of the invention receive an example of a web page as an input where a single data record to be extracted is manually marked. The method can then determine corresponding data records in other web pages.

An XPATH expression corresponding to the marked record is presented to the user. The user selects a part of the XPATH expression that corresponds to a record node representing the data records to be extracted. The entire structure of the sub-tree whose root is the record node is stored, along with the path to all data fields within this sub-tree. At run-time, the stored sub-tree is matched to the DOM-tree of new instances of the web page. For every match, data fields are extracted according to the stored paths in the record node sub-tree.

### BRIEF DESCRIPTION OF THE DRAWINGS

FIG. 1 is a flow diagram of a method for extracting data from a web page according to the embodiments of the invention;

FIG. 2 is a flow diagram of a method for constructing a record node sub-tree and data field sub-paths according to the embodiments of the invention;

FIG. 3 is a flow diagram of a method for extracting data from a web page according to the embodiments of the invention;

FIG. 4 is a block diagram of a user interface according to the embodiments of the invention; and

FIG. 5 is a block diagram of a visual selection of a record node according to one embodiment of the invention.

### DETAILED DESCRIPTION OF THE PREFERRED EMBODIMENTS

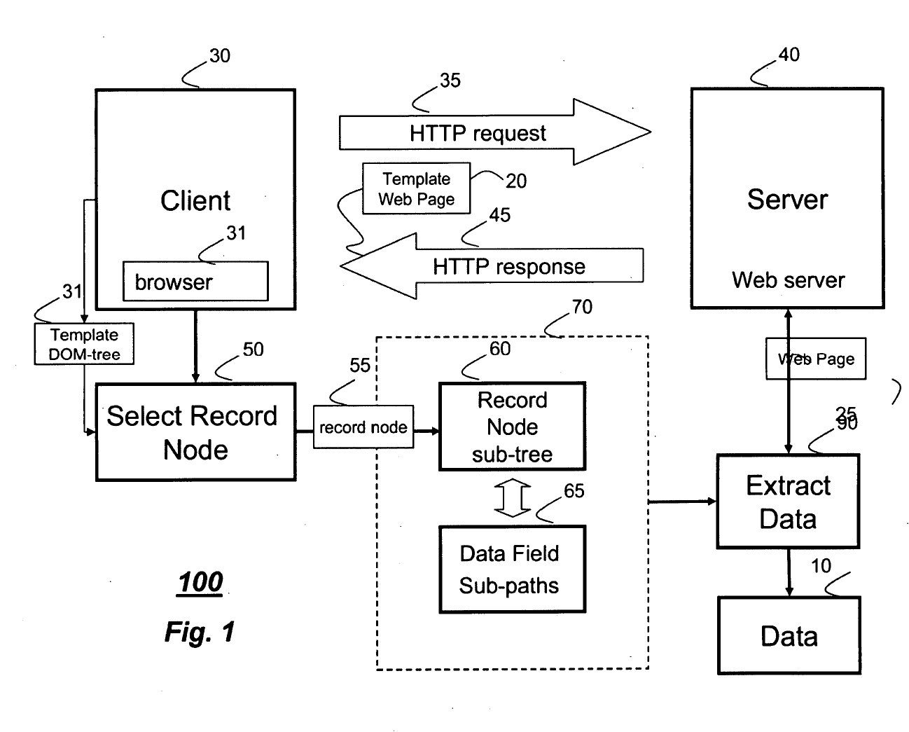

FIG. 1 shows a method 100 for extracting 90 data 10 from a web page 25. A client computer (client) 30 requests 35 a template web page 20 from a web server computer (server) 40. The client 30 is usually a personal computer operated by a user. In one embodiment of our invention, the client 30 works without user intervention.

In one embodiment, the client 30 loads the template web page 20 with help of a web browser 31. However, other application could be utilized for web page processing, e.g., XML editors.

In preferred embodiment of our invention, the server 40 is a web server. The client 30 sends the HTTP request 35 to the server 40 and receives the template web page 20 within the HTTP response 45 from the server 40.

Some embodiments of our invention utilize different transmission control protocols (TCP) and different types of servers. For example, one embodiment of our invention uses the file transfer protocol (FTP) and the server 40 is a FTP server.

In one embodiment, the client 30 loads the template web page 20 with help of the web browser. The web browser generates a template DOM-tree 31 that represents the template web page 20. A record node 55 is selected 50 and a record node sub-tree 60 and data field sub-paths 65 are stored in a memory 70. The memory can be part of the client 30, the server, or another computer. The memory 80 could be any type of computer memory, e.g., random access memory (RAM).

The record node 55 is the root node of the record node sub-tree, the sub-tree of the web page's DOM-tree that holds the data 10. Paths from the record node 55 to the data fields that hold data 10 are the data field sub-paths. New web page 25 have similar structure to the template web page 20, i.e., a variable number of data records, each of which has the same structure as the data records of the template web page 20. When the web page 25 is retrieved from a server, e.g., the server 40, the record node sub-tree 60 and the data field sub paths 65 are used to extract 90 the data 10.

Learning Stage

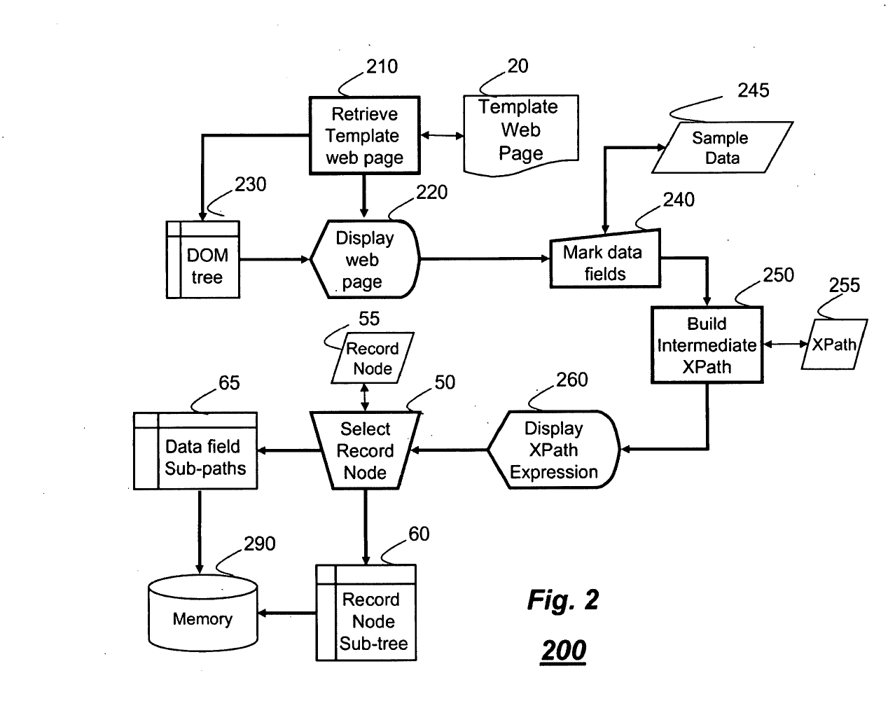

FIG. 2 shows the method 200 for retrieving the record node sub-tree 60 and the data field sub paths 65 from the template web page 20. The template web page 20 is retrieved 210 from the server 40 and displayed 220. The template DOM-tree 230 that represents the template web page 20 is generated by the browser. Alternatively, the template DOM-tree 230 can be constructed from the template web page 20 by other software.

The user locates data fields, and marks 240 the sample data 245 of interest within that record. The method 200 constructs 250 an intermediate XPath expression 255 for retrieving the sample data 245 and displays 260 the expression 250 to the user.

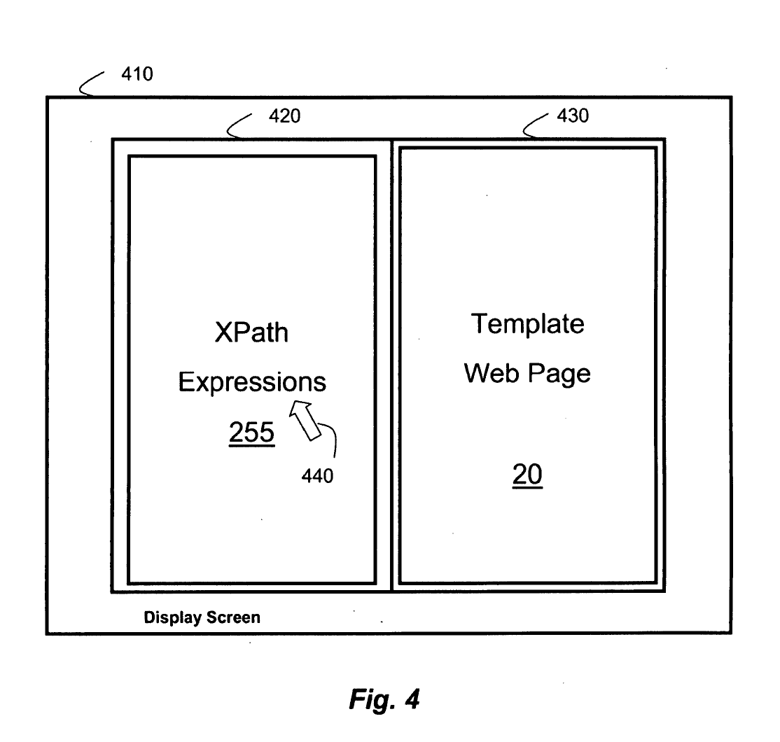

As shown on FIG. 4, in the preferred embodiment of the invention, the template web page 20 is displayed on a first portion 430 of a display screen 410, and the XPATH expression 255 is displayed on a second portion 420 of the display screen 410.

The user manually selects the record node 55 that corresponds to a minimal root node of a data sub-tree, i.e., the sub-tree of the template DOM-tree that holds the sample data 245. For example, if the sample data 245 are part of a table of the web page 20, the record node 55 is a corresponding table node.

In one embodiment, the user can select the record node 55 by moving a cursor 440 over the XPATH expression 255, e.g., from the left to the right of the expression 255. While the user moves the cursor 440 over the expression 255, the portion of the web page that corresponds to a node indicated by the cursor position is highlighted.

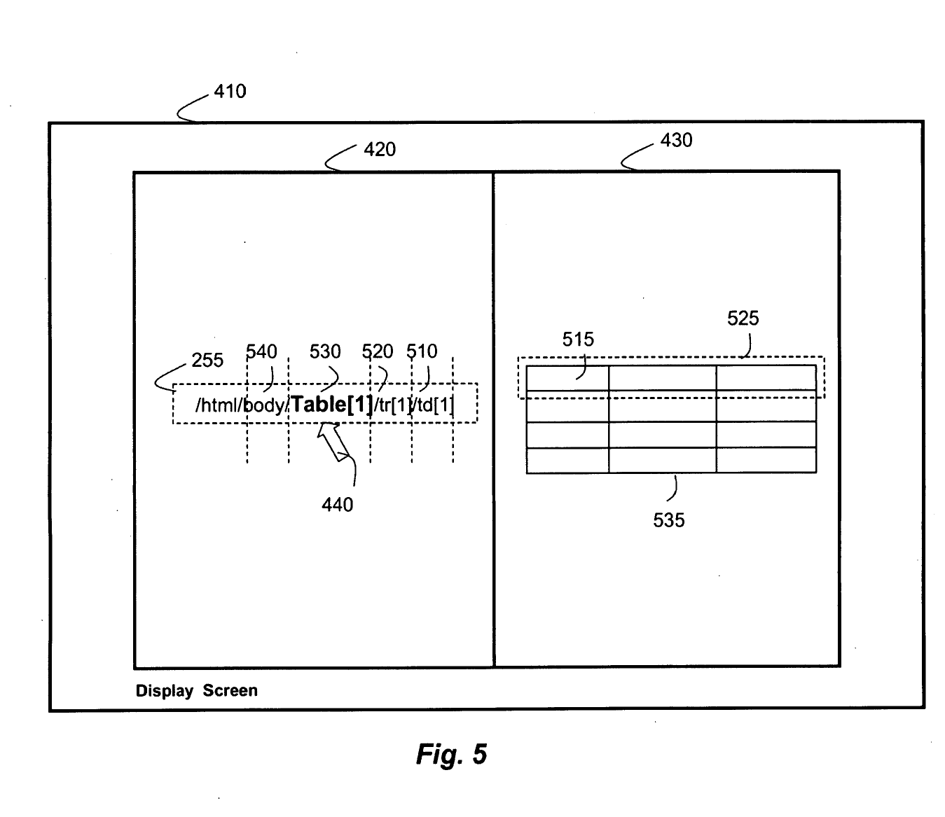

FIG. 5 shows an example of the selection of the record node 55. As described above, the template web page 20 is displayed on the first portion 430 of a display screen 410, and the XPATH 255 expression is displayed on the second portion 420 of the display screen 410. If the user places the cursor 440 over a part 510 of the XPATH expression 255, which corresponds to the first column 515 of the first row 525 of the first table 535 of the template web page 20, the column 515 is highlighted on the first portion 430 of the screen 410. If the user places the cursor 440 over the part 520 of the XPATH expression 255, the row 525 is highlighted. Similarly, if the user places the cursor 440 over the part 530 or 540 of the expression 255, the table 535 or the entire web page 20 is highlighted.

Thus, by moving the cursor over the XPATH expression 255, the user can indicate the part of the template web page 20 that corresponds to the selected record node. For example, if the user wants to extract data 10 from the whole table 535, then the user selects the record node 55 that corresponds to the table 535. When the user moves the cursor over the expression 255, the user selects a node 440 at the cursor when the entire table 535 is highlighted, i.e., the table[1] node 530.

Alternatively, in other embodiments of the invention, the user highlights the portion of the template web page 20 with the cursor and the node corresponding to the highlighted portion is selected as the record node 55. Alternatively, if the user is familiar with XPATH expressions, then the user can manually or programmatically select the record node 55.

When the record node 55 is selected, the record sub-tree 60, which is the entire structure of the DOM sub-tree whose root node is the record node 55, is stored in memory 290 for subsequent use. Similarly, the data field sub-paths 65, which are the relative paths from the record node 55 to the leaf node corresponding to the data fields, are stored in memory 290.

One embodiment automatically selects the record node sub-tree 60. In this embodiment, a lowest common ancestor (LCA) to all leaf nodes corresponding to the sample data 245, i.e., a LCA DOM-tree node, is determined using an LCA algorithm, e.g., Tarjan, “Applications of Path Compression on Balanced Trees,” Journal of the ACM (JACM), v.26 n.4, pp. 690-715, October 1979, incorporated herein by reference.

The structure of the LCA sub-tree whose root node is the LCA node corresponds to a part of the record node sub-tree 60. By matching the LCA sub-tree to all sub-trees of the template web page 20, it is possible to identify the corresponding data fields in all other records in the web page. The LCA node of all roots of matching sub-trees is the node that is the parent of all record sub-trees. Usually, this node corresponds to a table or a list. Therefore, the structure of the sub-tree whose root is one child of this LCA node can be stored in the memory 290 as the structure of the record node sub-tree 60.

Extraction Stage

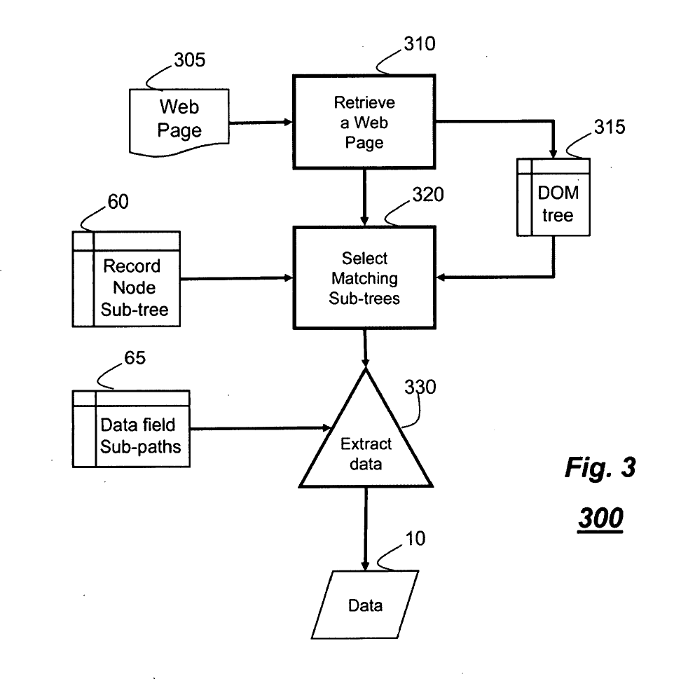

FIG. 3 shows the steps of a method 300 for extracting the data from the web page using the record node sub-tree 60 and data field sub-paths 65 according to the embodiments of the invention. During an extraction stage, a web page 305 is retrieved 310. The web page 305 should have the same basic structure of the data records, but possibly a different number of records, as the template web page 20. The DOM-tree 315 of web page 305 is constructed by the web browser. Within the DOM-tree 315, the structure of the record node sub-tree 60 is matched to the structure of all sub-trees.

In one embodiment, the DOM-tree 315 of the web page 305 is traversed in a suitable order, for example depth-first search, and the structure of each sub-tree of the web page 305 is compared to the structure of the stored record node sub-tree 60 to select 320 the matching sub-tree. A successful match occurs when tags of all nodes of the two trees that are not leaf nodes match, and all matching nodes have the same number of descendents in the two sub-trees. When the match is detected, the matched sub-tree of the DOM-tree of the new web page 305 corresponds a data record. Furthermore, using the pre-stored data field sub-paths 65, the data 10 is extracted 330 from all discovered data records.

Another embodiment of the invention traverses the template web page 20 with the record node sub-tree 60 to identify other parts of the template DOM-tree 230 with the structure of the record node sub-tree 60. Every identified match to a sub-tree of the template DOM-tree 230 corresponds to other data records of the same structure as that of the record node sub-tree 60.

When a match occurs, the method 100 keeps track of which leaf nodes of the record node sub-tree 60 change, and which leaf nodes do not change. Those leaf nodes, which do not represent formatting text, e.g., explanatory labels or names for the data fields, are labeled as non-formatting leaf nodes.

When matching the record node sub-tree 60 to all sub-trees of the DOM-tree 315, a match is identified only if the constant leaf nodes match in the two sub-trees. This embodiment increases the accuracy of identifying records in web page 305.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A computer-implemented method for extracting data from web pages, comprising the steps of:
receiving a template web page represented by a template Document Object Model (DOM);
selecting a record node, wherein the record node is a root node of a sub-tree of the template DOM that contains data to be extracted;
storing in a memory a record node sub-tree and data field sub-paths, wherein the record node is a root node of the record node sub-tree, and the data field sub-paths are relative paths of the template DOM from the record node to data field nodes;
receiving a web page represented by a DOM-tree;
identifying a matched sub-tree of the DOM-tree according to a structure of the record node sub-tree; and
extracting data from the matched sub-tree according to the data field sub-paths.

2. The method of claim 1, wherein the selecting step further comprises:
displaying the template web page on a first portion of a display screen;
identifying sample data that represent a location of data to be extracted in the template web page; and
displaying on a second portion of the display screen a XPATH expression corresponding to the sample data.

3. The method of claim 2, further comprising:
moving a computer mouse pointer over the XPATH expression to indicate a current record node;
highlighting programmatically a portion of the template web page which corresponds to the current record node; and
selecting the current record node as the record node when the data to be extracted is highlighted on the first portion of the display screen.

4. The method of claim 2, further comprising:
selecting manually by a user the record node out of nodes of the XPath expression.

5. The method of claim 1, wherein the selecting step further comprises:
displaying the template web page on a display screen;
highlighting manually by a user a part of the template web page; and
identifying a part of the template DOM corresponding to the highlighted part of the template web page; and
selecting a minimal root node of the part of template DOM as the record nod.

6. The method of claim 1, wherein the selecting step further comprises:
identifying sample data fields in the template DOM;
determining a lowest common ancestor (LCA) to leaf nodes corresponding to the sample data fields;
comparing a LCA sub-tree with sub-trees of the template DOM to identify matching sub-trees, wherein the LCA sub-tree is a sub-tree of the template DOM in which the LCA node is a root node; and
selecting a lowest common ancestor node for all matching sub-trees as the record node.

7. The method of the claim 1, wherein the matched sub-tree has all tags of non-leaf nodes matched with corresponding tags of the record node sub-tree.

8. The method of the claim 7, further comprising:
identifying constant leaf nodes of the record node sub-tree; and
selecting sub-trees out of the matched sub-trees, where corresponding leaf nodes match to the constant leaf nodes.
